(19) United States
(12) Patent Application Publication
(10) Pub. No.: US 2013/0155101 A1
(43) Pub. Date: Jun. 20, 2013

(54) SYSTEM AND METHOD FOR DISPLAYING CONTENT IN AN EXCLUSIVE MODE ENVIRONMENT

(71) Applicant: Wayne C. Louie, Port Perry (CA)

(72) Inventor: Wayne C. Louie, Port Perry (CA)

(73) Assignee: ATI Technologies, ULC, Markham (CA)

(21) Appl. No.: 13/326,954

(22) Filed: Dec. 15, 2011

(51) Int. Cl. G09G 5/377

(52) U.S. Cl. 345/629

(57) ABSTRACT

The present disclosure relates to a method and system for providing an image for display on a monitor. A method for providing an image for display includes detecting an exclusive display mode. In the exclusive display mode, an application is blocked from display on a monitor. In response to detecting the exclusive display mode, a composited surface is generated that comprises display data of a blocked application surface and display data of an exclusive application surface. A disclosed system includes a display mode detector that detects an exclusive display mode and a surface compositing module that causes a generation of a composited surface.

### FIELD OF THE DISCLOSURE

The present disclosure is generally related to the field of image display systems, and more particularly to methods and systems for causing the display of blocked content.

### BACKGROUND

Image display systems typically include a processor or other control unit that includes an operating system for controlling one or more applications. A monitor, such as a display, a screen, or other display medium, for example, may also be provided if desired to display content generated by or associated with an application (e.g. a software or firmware application). Such content can include graphics and/or video image data or any other visual data provided for display on the display medium. In some systems, multiple monitors are provided for displaying content from one or more applications.

Some operating systems operate in an exclusive mode environment wherein an application is granted exclusive control or ownership of the monitor. Such an exclusive mode application controls the content displayed on the monitor and causes the operating system to block other applications from simultaneously displaying content on the monitor. Further, the operating system often allocates one or more input devices for exclusive use with the exclusive mode application and blocks the use of the input devices with other applications. By preventing other applications from displaying content on the exclusively owned monitor and by restricting use of input devices, access by a user to the other applications is restricted or blocked in the exclusive mode environment. Some exemplary applications that are configured to operate in an exclusive mode environment include Metro user interface (UI) and DirectX applications available from Microsoft Corporation. Other operating systems also provide for similar exclusive mode environments.

Therefore, a need exists for methods and systems to allow a blocked application to display content on a monitor that is exclusively owned by an exclusive mode application.

### SUMMARY OF EMBODIMENTS OF THE DISCLOSURE

In an exemplary embodiment of the present disclosure, a method carried out by an image display system is provided. The method includes, responsive to a detection of an exclusive display mode, whereby an application is blocked from displaying data on a monitor, causing a generation of a composited surface comprising display data of a blocked application surface and display data of an exclusive application surface.

Among other advantages, the method and image display system allow a blocked application to display content on a monitor that is exclusively owned by an exclusive mode application. Other advantages will be recognized by those of ordinary skill in the art.

In one example, the method further includes generating the composited surface comprising the blocked application surface and the exclusive application surface. In another example, the method further includes displaying the composited surface comprising the blocked application surface and the exclusive application surface on a monitor designated as an exclusive monitor by, for example, an operating system. In yet another example, the method further includes linking the blocked application with an input device and providing control information to the blocked application with the input device during the exclusive display mode for controlling the composited surface. In still another example, causing the generation of the composited surface further includes instructing, by the blocked application, a surface compositing module to composite the blocked application surface with the exclusive application surface. In one example, an operating system operates in the exclusive display mode to block the application from displaying data on the monitor. In another example, the blocked application uses a communication channel that is operative to bypass the exclusive display mode of the operating system to instruct the surface compositing module to composite the blocked application surface with the exclusive application surface.

In another exemplary embodiment of the present disclosure, a system configured to provide an image for display is provided. The system includes a display mode detector operative to detect an exclusive display mode wherein an application is blocked from displaying content on a monitor. The system further includes a surface compositing module operatively coupled to the display mode detector and operative to cause a generation of a composited surface comprising a blocked application surface and an exclusive application surface. In one example, an operating system operatively coupled to the display mode detector operates in the exclusive display mode to block the application from displaying content on the monitor.

In yet another exemplary embodiment of the present disclosure, a computer-readable medium is provided comprising executable instructions such that when processed by at least one processor cause the at least one processor to detect an exclusive display mode wherein an application is blocked from displaying content on a monitor. The executable instructions further cause the at least one processor to, in response to detecting the exclusive display mode, cause a generation of a composited surface comprising a blocked application surface and an exclusive application surface. In one example, an operating system operates in the exclusive display mode to block the application from displaying content on the monitor.

### BRIEF DESCRIPTION OF THE DRAWINGS

The invention will be more readily understood in view of the following description when accompanied by the below figures and wherein like reference numerals represent like elements:

FIG. 1 is a block diagram of a prior known image display system including an application with exclusive ownership of a monitor;

FIG. 2 is a block diagram of an image display system in accordance with an embodiment including a blocked application with an exclusive override module, a driver with a surface compositing module, and an exclusive override input device with an exclusive override input controller;

FIG. 3 is a flow chart of an exemplary method of operation for causing generation of a composited surface comprising a blocked application surface and an exclusive application surface;

FIG. 4 is a flow chart of an exemplary method of operation of the exclusive override module of the blocked application of FIG. 2;

FIG. 5 is a flow chart of an exemplary method of operation of the surface compositing module of the driver of FIG. 2; and

FIG. 6 is a flow chart of an exemplary method of operation of the exclusive override input controller of FIG. 2.

### DETAILED DESCRIPTION

As referenced herein, an image display system includes any device or group of devices that causes an image to be displayed on one more monitors. A surface includes image or display data, such as a frame or lines of graphics or video data, for example, that has been processed or rendered by at least one processor for display on a monitor. In one embodiment, a surface is stored in a frame buffer prior to being displayed on a monitor.

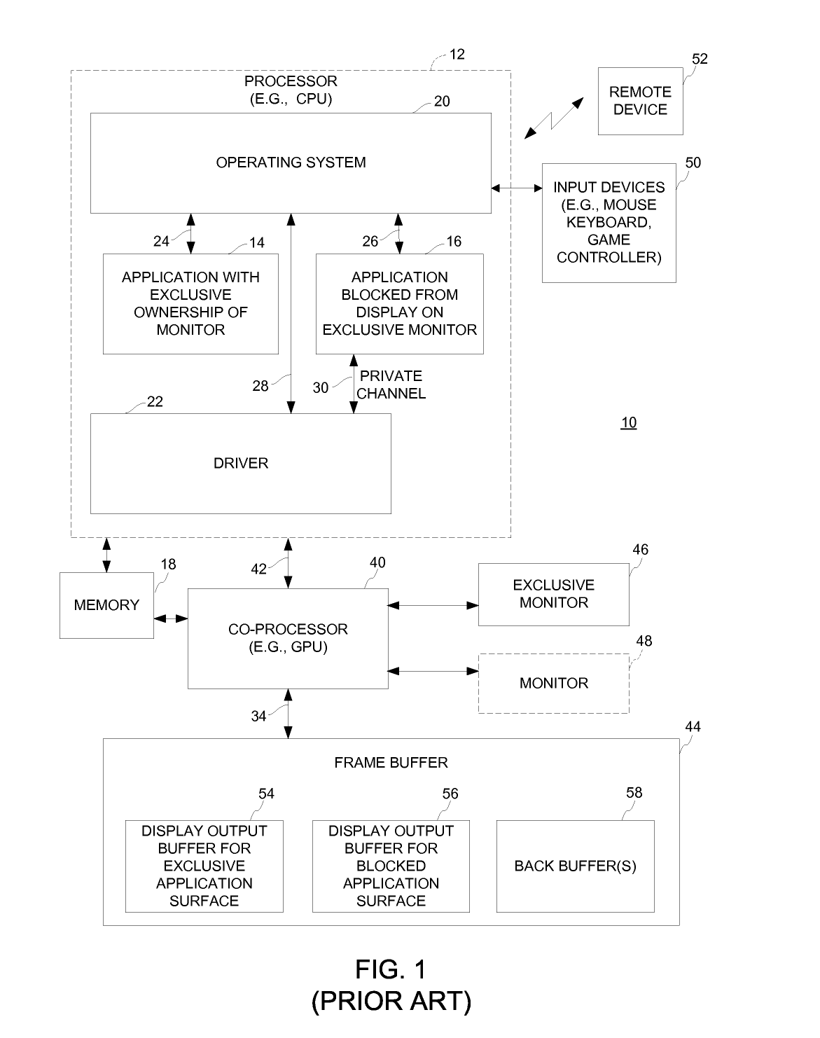

FIG. 1 illustrates an exemplary known image display system 10 including a processor 12 and a co-processor 40. Image display system 10 may include, for example, computing devices such as notebook computers, desktop computers, mobile devices (e.g., tablets, smart phones, and other mobile computing systems), and the like. Processor 12 is illustratively a central processing unit (CPU) 12 including an operating system 20 configured to execute one or more applications 14, 16. Applications 14, 16 are illustratively software or firmware stored in an internal memory of CPU 12, although applications 14, 16 may alternatively be stored in memory external to CPU 12, such as in memory 18. Memory 18 includes, for example, one or more storage mediums for storing data utilized by CPU 12 and/or GPU 40. Applications 14, 16 may alternatively include hardware external to CPU 12. Applications 14, 16 include program instructions that when executed by CPU 12 (and/or another processor) cause CPU 12 (and/or another processor) to perform one or more computing tasks. Operating system 20 of CPU 12 communicates with applications 14, 16 via respective communication channels or paths 24, 26.

Co-processor 40, illustratively a graphics processor unit (GPU) 40, is coupled to CPU 12 via communication bus 42. GPU 40 processes graphics and/or video image data based on instructions from CPU 12 (and/or another processor) and outputs the processed image data to a memory 44, illustratively a frame buffer 44, for displaying on a monitor 46 of image display system 10. In one embodiment, GPU 40 grabs the image data from a memory, such as memory 18, external to CPU 12 and GPU 40 and outputs rendered image surfaces to frame buffer 44 based on instructions from CPU 12. While CPU 12 and GPU 40 are illustratively separate devices with a communication bus 42 for communicating data between the two devices, CPU 12 and GPU 40 may alternatively be incorporated into a single chip package or other suitable structure. Image display system 10 may include one or more additional monitors 48 for displaying image data provided with GPU 40. Monitors 46, 48 include displays or screens, such as liquid crystal displays (LCD) or cathode ray tube (CRT) displays, or other suitable display mediums.

CPU 12 includes a driver 22 controlled by operating system 20 via communication path 28. Driver 22 includes a software or firmware program stored in internal or external memory containing instructions executable by CPU 12 for driving GPU 40. Based on commands from operating system 20, driver 22 directs GPU 40 via communication bus 42 to effect display of graphics and/or video image data. Applications 14, 16 requests operating system 20 to display a graphics or video image, and operating system 20 instructs driver 22 to cause GPU 40 to display the image.

Frame buffer 44 includes physical memory, such as random access memory (RAM), although other suitable memory types may be used. Frame buffer 44 includes one or more display output buffers 54, 56 for storing image surfaces provided by GPU 40. In particular, upon processing graphic or video data based on applications 14, 16, GPU 40 stores the rendered graphic/video data as image or display surfaces in frame buffer 44 via communication bus 34. A surface stored in frame buffer 44 includes image content or data, such as a frame of graphics or video data, that has been rendered or processed by GPU 40 and is ready for display on monitor 46. The surfaces are stored in frame buffer 44 until GPU 40 displays the surfaces on monitor 46 (and/or monitor 48).

Image surfaces rendered for application 14 are stored in display output buffer 54, and image surfaces rendered for application 16 are stored in display output buffer 56. Frame buffer 44 may also include one or more back buffers 58 that are used to store additional image surfaces, such as a rendered surface that awaits display on monitor 46 by GPU 40 after another surface in buffer 54 or buffer 56 is displayed. Frame buffer 44 may include additional buffers for storing other image data. In one embodiment, frame buffer 44 stores other forms of image data, such as textures, color palettes, shader code, maps (e.g., mipmmaps), vertices, wireframes (e.g. lines and curves), solids, etc.

A private, unidirectional or bi-directional communication channel 30 is provided between application 16 and driver 22. Communication channel 30 is private in that it allows direct communication between application 16 and driver 22. Communication channel 30, which may include one or more communication paths (e.g. electrical conductors) on CPU 12, is used for any suitable communication, such as, for example, instructions and data from application 16 to driver 22 that affects the operation and behavior of driver 22 and GPU 40. For example, application 16 may provide calls to the driver 22 via channel 30 including escape calls and/or input/output controls (IOCTL). Such calls are provided by application 16 to instruct driver 22 regarding settings or features of driver 22, such as image generation settings (e.g., color settings, shading, etc.). As such, when operating system 20 calls driver 22 to direct the generation or decoding of image data with GPU 40, driver 22 directs GPU 40 according to the settings and commands set forth in the calls from application 16. In one embodiment, settings and features set forth in calls from application 16 are input by a user through a control panel, although the calls from application 16 to driver 22 may alternatively be automatic. In one embodiment, the settings and features set forth in the calls from application 16 are stored in a buffer, such as frame buffer 44, that is accessed by driver 22 upon being called by the operating system 20. A communication channel may also be provided between driver 22 and application 14 or other applications.

One or more input devices 50 are operatively coupled to CPU 12 for user input controls and other communication with CPU 12. Exemplary input devices 50 include a keyboard, mouse, game controller, touchpad, or other suitable input device 50. A wireless remote device 52 may also be included to provide user input to and receive data from CPU 12 via wireless communication (e.g. radio frequency, infrared, etc.).

When neither application 14, 16 is granted an exclusive display mode status by operating system 20 or otherwise obtains such exclusive display mode status, image content provided by applications 14, 16 and stored in respective buffers 54, 56 may be displayed simultaneously on monitor 46. In particular, driver 22 may cause image content from application 16 to be composited with image content from application 14, and the composited image may be displayed on monitor 46. The composited image may include a first image surface overlayed on a second image surface, a first image surface merged or blended with a second image surface, a first image surface side by side, wholly or partially, with a second image surface, or any other suitable composited form of two or more image surfaces. For example, application 14 may include a video game application configured to display a gaming environment on monitor 46. Application 16 may include a control panel application configured to display a control panel window or property sheet over the entire or a portion of the displayed gaming environment. In this example with applications 14, 16 both operating in a non-exclusive environment, operating system 20 allows a user to view and to access the control panel application via the displayed control panel window using an input device 50, 52 (e.g. with a mouse cursor or other input mechanism) while the gaming application is active and simultaneously displayed in the background.

In image display system 10 of FIG. 1, operating system 20 is configured to grant exclusive ownership of monitor 46 to an application, illustratively application 14. Operating system 20 may grant exclusive ownership of monitor 46 to application 14 automatically or upon request by the application 14 for exclusive mode status. In this configuration, the exclusive application 14 controls the content displayed on monitor 46, and other applications (e.g., application 16) are blocked from displaying content on monitor 46. In such an exclusive mode environment, GPU 40 is directed to display only the surfaces in the exclusive application buffer 54 on monitor 46 and to not display surfaces contained in the blocked application buffer 56 on monitor 46. In one embodiment, operating system 20 further grants the exclusive application 14 exclusive ownership of one or more input devices 50, 52 and blocks the use of the input devices 50, 52 with blocked application 16. Because the display of content from application 16 and the use of input devices 50 with application 16 are blocked, access by a user to the blocked application 16 (e.g. via an input device 50, 52) is prevented by operating system 20 in the exclusive mode environment.

In one embodiment where image display system 10 includes additional monitor(s) 48, operating system 20 grants the exclusive application 14 exclusive control of both monitor 46 and monitor 48 and of input devices 50, 52. In another embodiment, operating system 20 grants the exclusive application 14 exclusive control of monitor 46 and input devices 50, 52 but non-exclusive control of monitor 48. In this embodiment, application 16 is blocked from displaying content on monitor 46 and is allowed to display content on monitor 48, but a user is not able to access or manipulate the displayed content of application 16 on monitor 48 because the input devices 50 are allocated for use only with exclusive application 14. For example, the content provided with application 16 is displayed on monitor 48, but a user is unable to provide input to or manipulate the displayed content (e.g. access a displayed link or icon with a cursor or other input mechanism) due to the exclusive mode status granted to application 14.

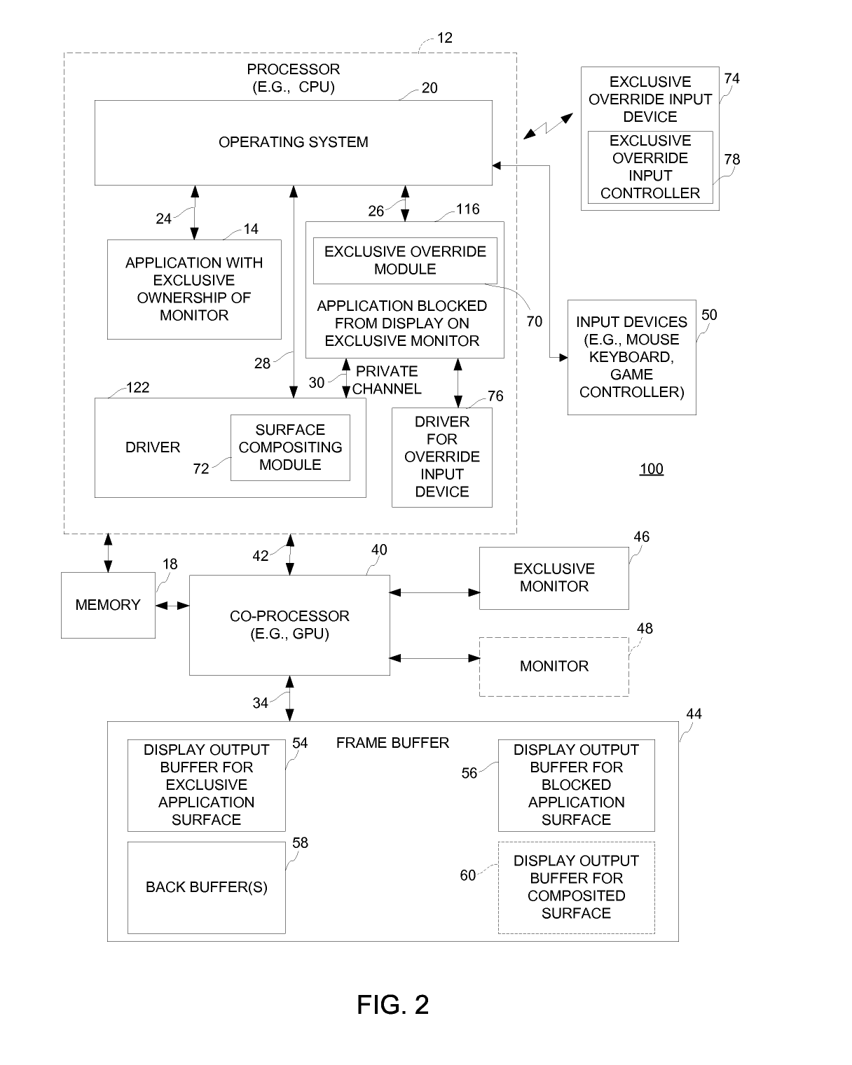

FIG. 2 illustrates an exemplary image display system 100 according to various embodiments that is configured to allow content of a blocked application 116 to be displayed on exclusive monitor 46 simultaneously with content of exclusive application 14 during an exclusive display mode and to be accessible by a user via an input device. Image display system 100 may be viewed as modifying the known image display system 10 described in FIG. 1. Like components of image display system 10 of FIG. 1 and image display system 100 of FIG. 2 are provided with like reference numbers. Various other arrangements of internal and external components and corresponding connectivity of image display system 100, that are alternatives to what is illustrated in the figures, may be utilized and such arrangements of internal and external components and corresponding connectivity would remain in accordance with the embodiments herein disclosed.

Blocked application 116 of FIG. 2 includes an exclusive override module 70 that facilitates overriding the exclusive display mode granted to application 14. Exclusive override module 70 serves as a display mode detector configured to detect an exclusive mode environment of operating system 20. In particular, module 70 includes software or firmware code stored in a memory of CPU 12 and containing instructions that when executed by CPU 12 identifies that operating system 20 has granted exclusive ownership of monitor 46 to application 14 and has blocked application 116 from displaying content on monitor 46. Module 70 is further configured to determine that operating system 20 has granted exclusive ownership of one or more input devices 50 to application 14 and has blocked the use of the one or more input devices 50 with application 116. Module 70 detects the exclusive mode environment by sending a request to operating system 20 via an application programming interface (API) for access to the exclusive monitor 46 and/or exclusive input devices 50 (and being denied access by operating system 20), by asking operating system 20 via API's for the disposition of the monitor 46 and/or exclusive input devices 50, by asking driver 22 via private channel 30 if the monitor 46 and/or exclusive input devices 50 are in exclusive mode, and/or other suitable detection methods.

Module 70 is further configured to instruct driver 122 to composite an image surface generated for or associated with blocked application 116 with an image surface generated for or associated with exclusive application 14. In particular, module 70 of blocked application 116 issues a composite request to driver 122 via private channel 30 that identifies an image surface of blocked application 116 that is to be composited with an image surface of exclusive application 14. In one embodiment, the blocked application surface identified in the composite request is stored in display output buffer 56 for application 116 while the exclusive application surface identified in the composite request is stored in display output buffer 54 for application 14. In one embodiment, the composite request identifies the memory locations of the blocked application surface and the exclusive application surface. In one embodiment, the composite request identifies all or a portion of the display data of the blocked application surface and of the exclusive application surface such that the composited surface includes all or a portion of the display data of each identified surface. The composite request from module 70 may further include a compositing method or technique to be used by driver 122 to composite the blocked application surface and the exclusive application surface. Exemplary compositing methods include alpha-blending, color-keying, etc. The composite request from module 70 may include additional compositing information, such as instructions for rescaling either or both image surfaces to fit side by side or partially overlapped, mask information used to determine which portion of each image surface to composite, instructions for using a palette of colors to determine which portion of each image surface to composite, etc.

Driver 122 of FIG. 2 includes a surface compositing module 72 operatively coupled to and in communication with exclusive override module 70 of blocked application 116 via private communication channel 30. Surface compositing module 72 includes software or firmware code stored in a memory of CPU 12 (and/or another processor) and containing instructions that when executed by CPU 12 (and/or another processor) causes driver 122 to cause a generation of a composited surface. In particular, surface compositing module 72 receives the composite request from blocked application 116 and, based on the composite request, directs GPU 40 to composite the entire or a portion of the identified blocked application surface in output buffer 56 and the entire or a portion of the identified exclusive application surface in output buffer 54. Although surface compositing module 72 is illustratively provided in driver 122, module 72 may alternatively be provided in another memory location of CPU 12 or another processor.

In the illustrated embodiment, driver 122 directs GPU 40 to store the composited surface in a display output buffer 60 of frame buffer 44, different from buffers 54, 56, until GPU 40 displays the composited surface on the exclusive monitor 46. Alternatively, the composited surface may be stored in buffer 54 or buffer 56. GPU 40 displays the composited surface stored in frame buffer 44 on the exclusive monitor 46 upon command from driver 122, although GPU 40 may also display the composited surface on monitor 48.

As such, the exclusive display mode of operating system 20 is overridden by the cooperation of exclusive override module 70 of blocked application 116 and surface compositing module 72 of driver 122 while utilizing private channel 30 to allow the blocked surface of application 116 to be composited with the exclusive surface of application 14 and displayed on monitor 46. The use of private channel 30 for communicating the composite request serves to bypass the exclusive display environment of operating system 20 such that blocked application 116 communicates the request directly with driver 122. In one embodiment, operating system 20 is aware of private channel 30, but private channel 30 serves to communicate content with driver 122 such that the composite request bypasses the restrictions of the exclusive display mode of operating system 20. With operating system 20 operating in the exclusive display mode, the transmission of the composite request from blocked application 116 directly to driver 22 avoids operating system 20 blocking the requested blocked application surface from display with the exclusive surface.

Depending on the type of application 116 and the content generated, the blocked application surface may occupy the entire display area of the exclusive application surface. In this configuration, compositing the blocked application surface with the exclusive application surface is not required because no portion of the exclusive application surface will be displayed on monitor 46. As such, driver 122, upon receiving the composite request from application 116, may instruct GPU 40 to display the blocked application surface directly on monitor 46 without first compositing the blocked application surface with the exclusive application surface.

In one example, module 70 communicates composite requests to driver 122 to perform various display operations and/or to display blocked content of application 116 automatically during the exclusive display mode of operating system 20. The automatic composite requests are issued by application 116 without input by a user during the exclusive display mode. For example, various values or operating parameters of CPU 12 (e.g., frame rate data of driver 122, etc.) are automatically displayed during the exclusive display mode. In another example, display settings or other settings are modified automatically by blocked application 116 and driver 122 during the exclusive display mode based on timer changes, state changes of driver 122, or other suitable triggers.

In one embodiment, the automatic composite requests are based on settings input by a user prior to operating system 20 entering the exclusive display mode. For example, prior to the exclusive display mode, a user configures blocked application 116 via a user interface (e.g. input device 50, 74) to control how and when blocked content is displayed or to control automatic display operations when operating system 20 is in the exclusive display mode. For example, in a control panel application 116, a user accesses a window or property sheet of the control panel application 116 with an input device 50, 74 prior to operating system 20 entering the exclusive display mode and configures a display operation to be performed and/or content to be displayed by blocked application 116 and driver 122 during the exclusive display mode. Upon operating system 20 entering the exclusive display mode, program module 70 and surface compositing module 72 cooperate to cause execution of the selected display operation or display of the selected content on monitor 46. In an embodiment where a display operation (e.g., automatic change of display settings, etc.) of blocked application 116 is implemented during the exclusive display mode, the composite request identifies the display operation to be performed such that driver 122 is configured to automatically perform the display operation based on the composite request without user input.

An exclusive override input device 74 illustrated in FIG. 2 is also configured to facilitate overriding the exclusive display mode of operating system 20. In particular, input device 74 is configured to provide control information and user input to blocked application 116 for controlling and manipulating displayed content and/or a display operation of blocked application 116 during both non-exclusive and exclusive display modes of operating system 20. Override input device 74 provides a user with access to and control of blocked application 116, such as, for example, when one or more input devices 50 are blocked by operating system 20 from use with application 116 during the exclusive display mode, as described herein.

An exclusive override input controller 78 of override input device 74 includes software or firmware code stored in a memory of input device 74 that controls communication with blocked application 116. Controller 78 receives input from a user of input device 74 and provides control information to blocked application 116 based on the user input. Exemplary control information provided with input device 74 includes information and settings for generating the blocked application surface to be composited with the exclusive application surface and for generating the composited surface. For example, the control information may cause the activation of module 70, select content of application 116 to be displayed, select display settings/effects (e.g., brightness, shading, contrast, etc.), identify the location of the displayed content on monitor 46 (or monitor 48), select which monitor 46, 48 displays the composited surface, and other suitable control information.

In one embodiment, a user activates module 70 of blocked application 116 with override input device 74 to enable the display of blocked content of application 116. Once enabled, blocked application 116 is configured to issue composite requests to driver 122 via channel 30. Settings and configuration information of module 70 are also entered with override input device 74. Further, the selection and control of the displayed blocked content and display operations of application 116 is controlled with override input device 74. Based on the settings and control information entered with device 74, module 70 of blocked application 116 issues composite requests to surface compositing module 72 to control the generation of the composited surfaces.

CPU 12 illustratively includes an override input device driver 76 in communication with blocked application 116 for linking the blocked application 116 with override input device 74. Driver 76, which includes a software or firmware program, is controlled by operating system 20 and is configured to enable and drive communication between override input device 74 and blocked application 116. In one embodiment, override input device 74 sends a request to driver 76 to request communication with blocked application 116, and in response driver 76 links override input device 74 to the blocked application 116 to allow communication therebetween. Input device 74 may be configured to automatically send a communication request to driver 76 upon input device 74 (or controller 78 of input device 74) being activated. Alternatively, input device 74 may issue the communication request upon receiving an input command from a user. Blocked application 116 may alternatively send a communication request to input device 74 via driver 76 to link blocked application 116 and input device 74. Driver 76 sends a confirmation signal to override input device 74 confirming that communication with blocked application 116 has been enabled.

Upon linking override input device 74 with the blocked application 116, override input device 74 is configured to provide control information and data, as described herein, to the blocked application 116 during the exclusive display mode of operating system 20 for controlling the composited surface(s). Alternatively, an input device 50 that is not reserved by operating system 20 for exclusive use with exclusive application 14 may be used to provide the control information/data and settings to blocked application 116. For example, special keys of a keyboard or other input device 50 may be assigned and configured to provide control input to blocked application 116 during an exclusive display mode. In this example, control input from the special keys is processed by firmware or software prior to the input reaching the operating system 20.

In one embodiment, blocked application 116 provides feedback to override input device 74 via driver 76. Exemplary feedback includes confirmation that input device 74 and application 116 are linked together for communication, confirmation of the receipt of various commands from input device 74, setting and display options that are available for selection by input device 74, and other suitable information.

Override input device 74 is illustratively a remote wireless device that communicates with driver 76 and blocked application 116 wirelessly (e.g. via radio frequency, infrared, Bluetooth, etc.). Override input device 74 may alternatively be in wired communication with blocked application 116, for example, coupled to an input port of image display system 100 for communicating with application 116. An exemplary override input device 74 includes a tablet computer (e.g. iPAD by Apple, Inc.), a mobile phone, a personal digital assistant (PDA), other handheld devices, a Bluetooth device (e.g. with Audio/Video Remote Control Profile, etc.), a digitizer, other non-DirectX devices, and other suitable input devices. In one embodiment, override input device 74 is further configured to control other programs and applications of CPU 12.

In one embodiment, a user selects a portion of exclusive monitor 46 onto which blocked application 116 composites content while in the exclusive display environment. For example, using a pointer or other selection mechanism provided with override input device 74 or a non-exclusive input device 50, a user selects a display area or portion of monitor 46. Module 70 of blocked application 116 or driver 122 stores the parameters of the selected display portion. Blocked application 116 then performs an operation based on the selected display portion and/or displays content within the selected display portion. For example, upon selection of the display portion of monitor 46 by a user, blocked application 116 performs an analysis of the selected display portion (e.g. a pixel color analysis using a histogram function, etc.) and displays the results of the analysis on monitor 46.

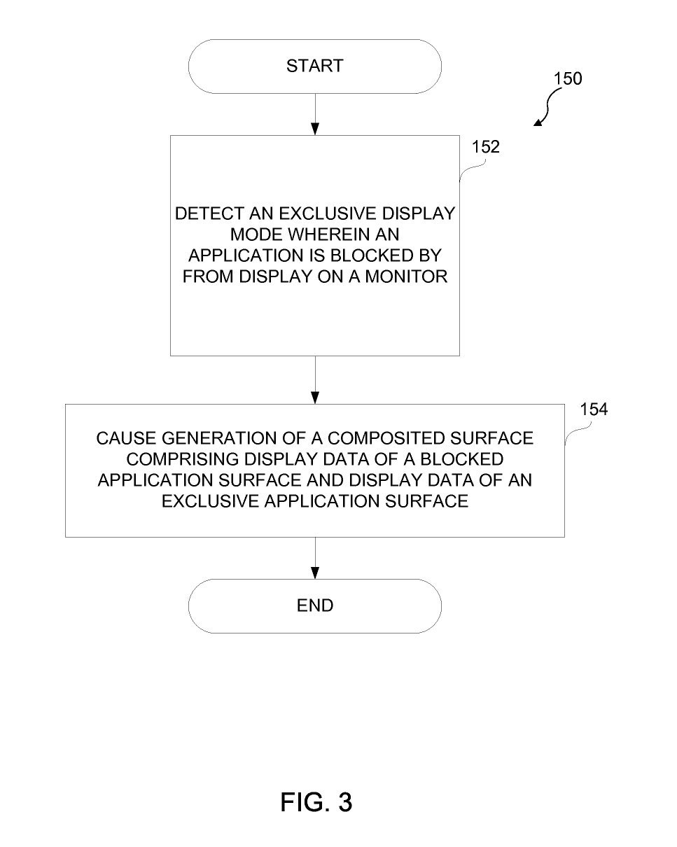

FIG. 3 illustrates a flow diagram 150 of an exemplary operation performed by image display system 100 of FIG. 2 for providing an image for display. At block 152, an exclusive display mode is detected wherein an application, such as application 116, is blocked from displaying data or content on a monitor, such as exclusive monitor 46. In one embodiment, operating system 20 operates in the exclusive display mode to block application 116 from displaying content on monitor 46, as described herein. At block 154, in response to detecting the exclusive display mode, the image display system 100 causes the generation of a composited surface comprising display data of a blocked application surface and display data of an exclusive application surface. The display data may include all or a portion of the respective blocked application surface and exclusive application surface.

In one embodiment, module 70 of blocked application 116 detects the exclusive display mode based on information provided with operating system 20. Driver 122 detects the exclusive display mode based on receipt of the composite request provided with module 70, although driver 122 may alternatively detect the exclusive display mode based on information provided with operating system 20. Upon detecting the exclusive display mode, module 70 provides a composite request to driver 122 to cause generation of a composited surface, as described herein. In one embodiment, in response to detecting the exclusive display mode, module 70 provides the composite request after application 116 requests generation of an image surface for display on exclusive monitor 46 (e.g. a blocked application surface stored at buffer 56). In response to receiving the composite request from application 116, driver 122 causes generation of the composited surface by instructing GPU 40 to composite the blocked application surface and exclusive application surface. GPU 40 then generates the composited surface comprising at least a portion of the blocked application surface and at least a portion of the exclusive application surface.

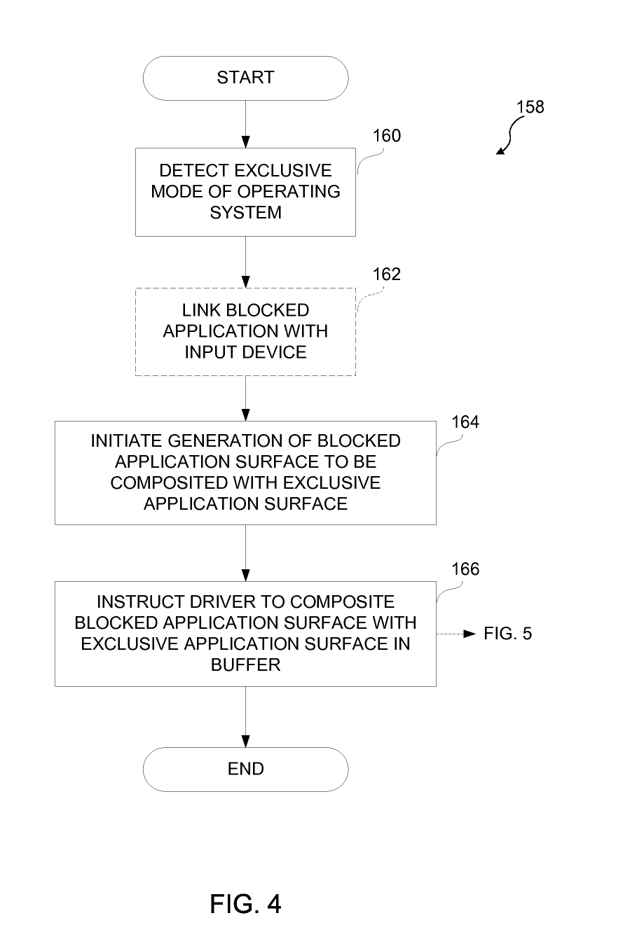

FIG. 4 illustrates a flow diagram 158 of an exemplary operation performed by exclusive override module 70 of application 116 of FIG. 2. At block 160, module 70 detects an exclusive display mode of operating system 20, as described herein. At block 162, module 70 optionally links blocked application 116 with an input device, such as input device 74 or a non-exclusive input device 50, for communicating with the input device, as described herein. Module 70 links application 116 with override input device 74, for example, by confirming a communication request by input device 74 or by requesting communication with input device 74, as described herein. Alternatively, module 70 may assign a non-exclusive input device 50 that is not reserved for exclusive application 14 to be used with blocked application 116. The operation of block 162 may alternatively be performed prior to detection of the exclusive display mode at block 160 or at another suitable time.

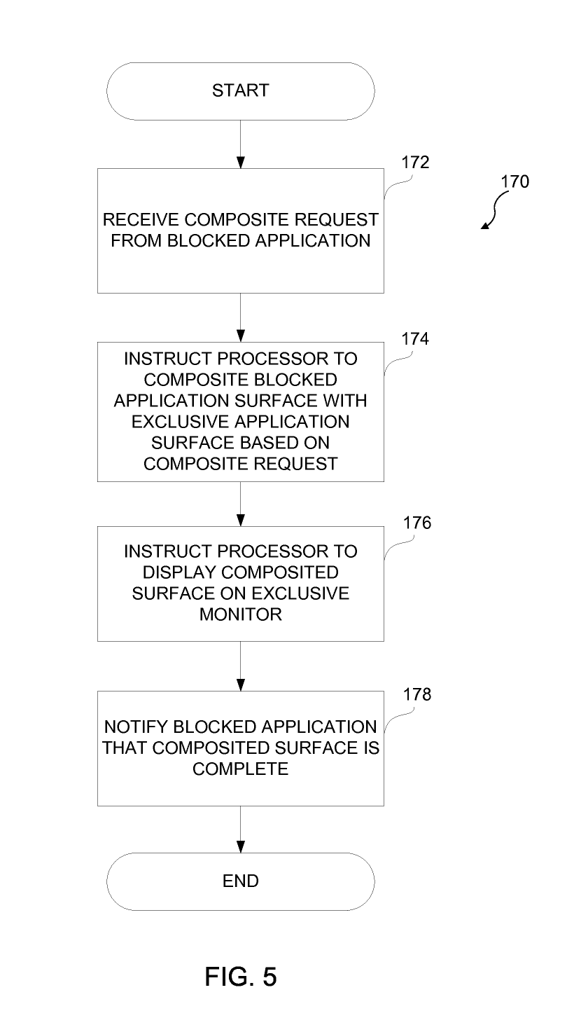

At block 164 of FIG. 4, module 70 initiates or causes the generation of a blocked application surface that is to be composited with an exclusive application surface of application 14. For example, blocked application 116 requests driver 122 (i.e., via operating system 20 or private channel 30) to direct GPU 40 to generate a surface for blocked application 116. In the illustrated embodiment, the generated blocked application surface is stored in display output buffer 56 until composited with an exclusive application surface. At block 166 of FIG. 4, module 70 of blocked application 116 issues a composite request to instruct surface compositing module 72 of driver 122 to composite the blocked application surface with an exclusive application surface stored in buffer 54, as described herein. The composite request is illustratively provided through communication channel 30. Based on the instructions received at block 166, driver 122 causes the generation of the composited surface, as illustrated in FIG. 5.

FIG. 5 illustrates a flow diagram 170 of an exemplary operation performed by surface compositing module 72 of driver 122 of FIG. 2. At block 172, surface compositing module 72 receives the composite request from blocked application 116. At block 174, surface compositing module 72 instructs at least one processor, illustratively GPU 40 of FIG. 2, to composite the blocked application surface with the exclusive application surface in a buffer for display based on information in the composite request, as described herein. GPU 40 then generates the composited surface based on information from driver 122 and stores the composited surface in display output buffer 60 or another suitable buffer. At block 176, surface compositing module 72 instructs GPU 40 to display the composited surface in buffer 60 on a display designated as an exclusive display by operating system 20 (e.g. exclusive monitor 46). At block 178, surface compositing module 72 notifies blocked application 116 via private channel 30 that the composited surface is complete, i.e., that the composited surface has been generated and/or displayed on monitor 46.

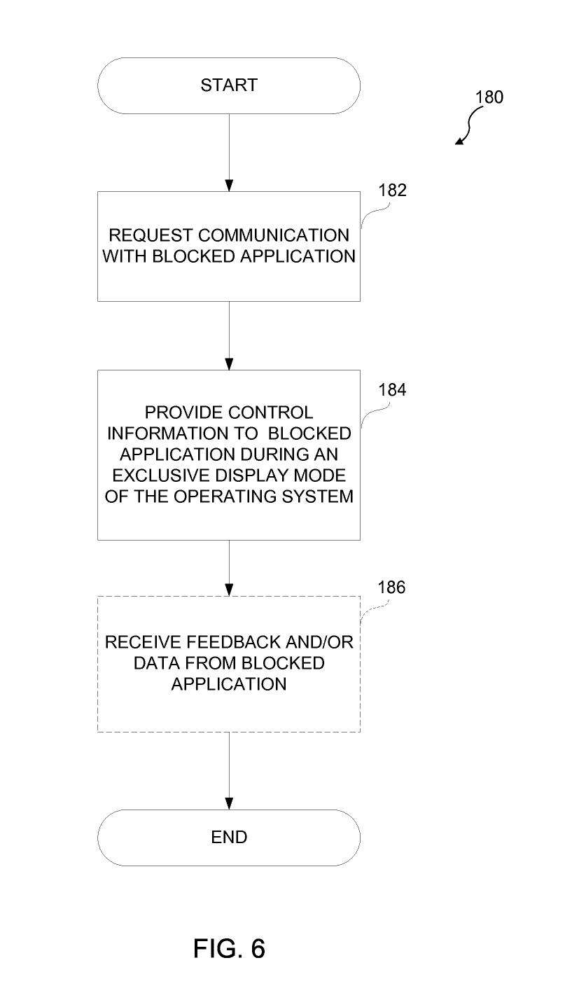

FIG. 6 illustrates a flow diagram 180 of an exemplary operation performed by exclusive override input controller 78 of override input device 74 illustrated in FIG. 2. At block 182, controller 78 requests communication with blocked application 116. Driver 76 transmits the request to blocked application 116 to link input device 74 with application 116, as described herein. Alternatively, application 116 may initiate the communication with input device 74 via driver 76. At block 184, controller 78 provides control information to blocked application during an exclusive display mode of the operating system 20 for controlling the composited surface, as described herein. The control information includes information for generating the blocked application surface, as described herein. In one embodiment, controller 78 receives feedback from blocked application 116, as illustrated at block 186. As described herein, exemplary feedback includes confirmation that input device 74 and application 116 are linked together and that various input is received. Other exemplary feedback includes indication to a user of input device 74 that a selected input is invalid or improper. In one embodiment, blocked application 116 provides a portion or all of a blocked surface or composited surface to input device 74 such that a user may view the surface on a display of input device 74.

Among other advantages, the method and image display system allow a blocked application to display content on a monitor that is exclusively owned by an exclusive mode application. Other advantages will be recognized by those of ordinary skill in the art.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

What is claimed is:

1. A method carried out by an image display system comprising:
responsive to a detection of an exclusive display mode, whereby an application is blocked from displaying data on a monitor, causing a generation of a composited surface comprising display data of a blocked application surface and display data of an exclusive application surface.

2. The method of claim 1, further comprising generating the composited surface comprising display data of the blocked application surface and display data of the exclusive application surface.

3. The method of claim 1, further comprising displaying the composited surface comprising display data of the blocked application surface and display data of the exclusive application surface on a monitor designated as an exclusive monitor.

4. The method of claim 1, further comprising:
linking the blocked application with an input device; and
providing control information to the blocked application with the input device during the exclusive display mode for controlling the composited surface.

5. The method of claim 4, wherein the control information includes information for generating the blocked application surface.

6. The method of claim 1, wherein causing the generation of the composited surface comprises:
causing a generation of the blocked application surface;
instructing, by the blocked application, a surface compositing module to composite the blocked application surface with the exclusive application surface; and
instructing, by the surface compositing module, at least one processor to composite the blocked application surface and the exclusive application surface in a buffer for display on the monitor.

7. The method of claim 6, wherein the exclusive application surface is provided in a first buffer for display on the monitor, and wherein the composited surface is provided in a second buffer different from the first buffer for display on the monitor.

8. The method of claim 6, wherein the blocked application uses a communication channel operative to bypass the exclusive display mode of an operating system to instruct the surface compositing module to composite the blocked application surface with the exclusive application surface.

9. The method of claim 6, wherein the blocked application provides a composite request to the surface compositing module to instruct the surface compositing module to composite the blocked application surface with the exclusive application surface, wherein the composite request identifies at least one of a memory location of the blocked application surface, a memory location of the exclusive application surface, and a compositing method for compositing the blocked application surface and the exclusive application surface.

10. The system of claim 1, wherein an operating system operates in the exclusive display mode to block the application from displaying data on the monitor.

11. The method of claim 10, wherein an exclusive mode application initiates the exclusive display mode of the operating system, and the exclusive mode application is configured to have exclusive control of the monitor in the exclusive display mode.

12. A system configured to provide an image for display, the system comprising:
a display mode detector operative to detect an exclusive display mode wherein an application is blocked from displaying content on a monitor; and
a surface compositing module operatively coupled to the display mode detector and operative to cause a generation of a composited surface comprising a blocked application surface and an exclusive application surface.

13. The system of claim 12, further including at least one processor operatively coupled to the surface compositing module and operative to generate the composited surface comprising the blocked application surface and the exclusive application surface.

14. The system of claim 13, wherein the surface compositing module is further operative to direct the at least one processor to display the composited surface comprising the blocked application surface and the exclusive application surface on a monitor designated as an exclusive monitor.

15. The system of claim 12, further including an input device linked to the blocked application and configured to provide control information to the blocked application during the exclusive display mode for controlling the composited surface.

16. The method of claim 15, wherein the control information includes information for generating the blocked application surface.

17. The system of claim 12, wherein the display mode detector is further operative to provide a composite request to the surface compositing module to instruct the surface compositing module to composite the blocked application surface with the exclusive application surface, and wherein the composite request is provided through a communication channel between the display mode detector and the surface compositing module that is operative to bypass the exclusive display mode.

18. The system of claim 16, wherein the composite request includes an identification of at least one of a memory location of the blocked application surface, a memory location of the exclusive application surface, and a compositing method for compositing the blocked application surface and the exclusive application surface.

19. The system of claim 12, wherein an operating system operatively coupled to the display mode detector operates in the exclusive display mode to block the application from displaying content on the monitor.

20. A computer-readable medium comprising:
executable instructions such that when processed by at least one processor cause the at least one processor to:
detect an exclusive display mode wherein an application is blocked from displaying content on a monitor; and
in response to detecting the exclusive display mode, cause a generation of a composited surface comprising a blocked application surface and an exclusive application surface.

21. The computer-readable medium of claim 20, wherein the executable instructions further cause the at least one processor to display the composited surface comprising the blocked application surface and the exclusive application surface on a monitor designated as an exclusive monitor by an operating system.

22. The computer-readable medium of claim 20, wherein the executable instructions further cause the at least one processor to:
link the blocked application with an input device; and
control the composited surface during the exclusive display mode based on control information received from the input device.
